(19) United States
(12) Patent Application Publication
(10) Pub. No.: US 2025/0021803 A1
(43) Pub. Date: Jan. 16, 2025

(54) INFORMATION PROCESSING APPARATUS, INFERENCE APPARATUS, AND CONTROL METHOD

(71) Applicant: CANON KABUSHIKI KAISHA, Tokyo (JP)

(72) Inventor: AKIHIRO TANABE, Tokyo (JP)

(21) Appl. No.: 18/767,157

(22) Filed: Jul. 9, 2024

(30) Foreign Application Priority Data
Jul. 11, 2023 (JP) 2023-113902

(51) Int. Cl. G06N 3/0464

(52) U.S. Cl. CPC G06N 3/0464

(57) ABSTRACT

An information processing apparatus generates a program for executing inference processing using a learned inference model, the generated program including a first program for executing first processing, the first program being generated based on first information concerning inference processing hardware of a first inference apparatus and a second program for executing second processing, the second program being generated based on second information concerning inference processing hardware of one or more second inference apparatus, and distributes the inference processing to the first inference apparatus to execute first processing and to one or more second inference apparatus connectable to the first inference apparatus to execute second processing.

### BACKGROUND

### Field

The present disclosure relates to a technique of expanding the function of an inference apparatus.

### Description of the Related Art

In the field of machine learning using Artificial Intelligence (AI), there is known a deep learning technique using a neural network. The deep learning technique is used for image processing that recognizes the face, expression, and the like of a person from a captured image, and the like. In image processing using the deep learning technique, a captured image or the like is applied as input data to a learned inference model and inference processing by machine learning is executed, thereby outputting an inference result.

The inference processing may be executed by a single inference apparatus. However, when more complex processing is performed, the hardware resources of the inference apparatus may be insufficient, and thus there is known a technique of expanding the function of the inference apparatus by connecting an expansion apparatus capable of executing inference processing to the inference apparatus. Japanese Patent Laid-Open No. 2022-133135 describes a technique in which a detachable device connected to an image capture apparatus executes analysis processing of a captured image.

According to Japanese Patent Laid-Open No. 2022-133135, the detachable device connected to the image capture apparatus can execute inference processing but the hardware resources of the image capture apparatus cannot be utilized for the inference processing.

### SUMMARY

The present disclosure has been made in consideration of the aforementioned problems, and realizes techniques of effectively utilizing, in a case where an expansion apparatus that expands the function of an inference apparatus is connected to the inference apparatus, the hardware resources of the inference apparatus and the expansion apparatus.

In order to solve the aforementioned problems, the present disclosure provides an information processing apparatus comprising: a generation unit that generates a program for executing inference processing using a learned inference model, the generated program including a first program for executing first processing, the first program being generated based on first information concerning inference processing hardware of a first inference apparatus and a second program for executing second processing, the second program being generated based on second information concerning inference processing hardware of one or more second inference apparatus; and a control unit that distributes the inference processing to the first inference apparatus to execute first processing and to one or more second inference apparatus connectable to the first inference apparatus to execute second processing.

In order to solve the aforementioned problems, the present disclosure provides an inference apparatus comprising: an inference unit that executes inference processing using a learned inference model; an interface unit that can connect one or more expansion apparatus for expanding a function of the inference processing; a determination unit that determines whether the expansion apparatus is connected by the interface unit; and a control unit that executes first processing in accordance with a predetermined condition, in a case where the inference processing is distributed to the first processing to be executed in the inference apparatus and second processing to be executed in the expansion apparatus.

In order to solve the aforementioned problems, the present disclosure provides a control method of an information processing apparatus that executes inference processing using a learned inference model, the control method comprising: distributing the inference processing to a first inference apparatus to execute first processing and to one or more second inference apparatus connectable to the first inference apparatus to execute second processing; and generating a program for executing the inference processing using the learned inference model, the generated program including a first program for executing the first processing, the first program being generated based on first information concerning inference processing hardware of the first inference apparatus and a second program for executing the second processing, the second program being generated based on second information concerning inference processing hardware of one or more second inference apparatus.

In order to solve the aforementioned problems, the present disclosure provides a control method of an inference apparatus which includes an inference unit that executes inference processing using a learned inference model, and an interface unit that can connect one or more expansion apparatus for expanding a function of the inference processing, the control method comprising: determining whether the expansion apparatus is connected by the interface unit; and executing first processing in accordance with a predetermined condition, in a case where the inference processing is distributed to the first processing to be executed in the inference apparatus and second processing to be executed in the expansion apparatus.

According to the present disclosure, in a case where an expansion apparatus that expands the function of an inference apparatus is connected to the inference apparatus, it is possible to effectively utilize the hardware resources of the inference apparatus and the expansion apparatus.

Further features of the present disclosure will become apparent from the following description of exemplary embodiments (with reference to the attached drawings).

### BRIEF DESCRIPTION OF THE DRAWINGS

FIG. 1 is a block diagram showing a system configuration including an inference apparatus and an expansion apparatus according to the present embodiment;

FIG. 2 is a block diagram showing the configuration of the inference apparatus according to the present embodiment;

FIG. 3 is a block diagram showing the configuration of an information processing apparatus according to the present embodiment;

FIG. 4 is a view exemplifying an inference program generation tool according to the present embodiment;

FIG. 5 is a flowchart illustrating control processing of the information processing apparatus according to the first embodiment;

FIG. 6 is a flowchart illustrating control processing of the information processing apparatus according to the first embodiment;

FIG. 7 is a flowchart illustrating control processing of the inference apparatus according to the first embodiment;

FIG. 8 is a flowchart illustrating control processing of an information processing apparatus according to the second embodiment; and

FIG. 9 is a block diagram showing a system configuration including an inference apparatus and an expansion apparatus according to the third embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

In the present embodiment, in a case where an expansion apparatus that expands the function of inference processing is connected to an inference apparatus that executes the inference processing using a learned inference model, arithmetic processes of respective processing layers in the inference model are appropriately distributed to the inference apparatus and the expansion apparatus. This makes it possible to effectively utilize the hardware resources of the inference apparatus and the expansion processing for executing the inference processing.

### First Embodiment

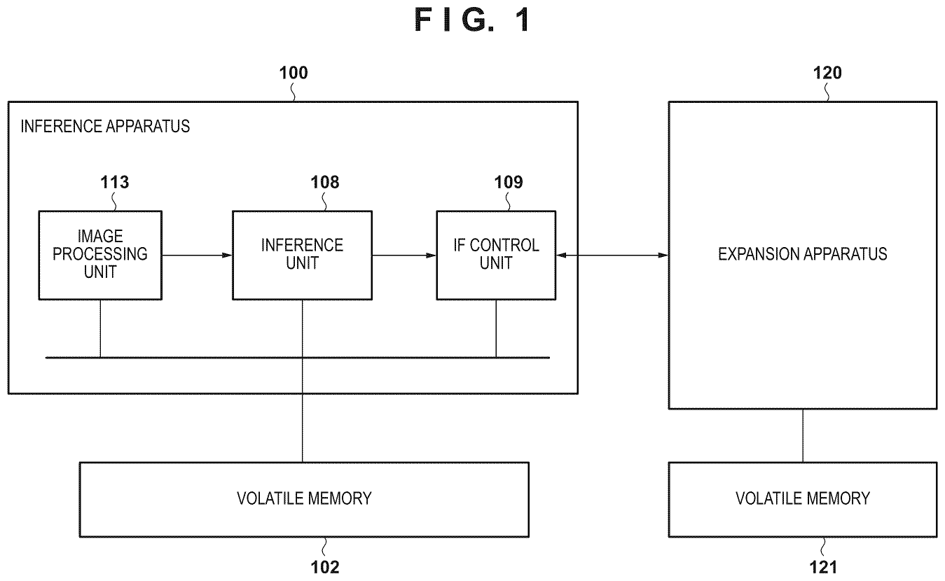

The first embodiment will be described with reference to FIGS. 1 to 7.

### <System Configuration>

A system configuration including an inference apparatus 100 and an expansion apparatus 120 according to the first embodiment will be described first with reference to FIG. 1.

The inference apparatus 100 is an image capture apparatus such as a digital camera, and has a deep learning function using a neural network of AI. The inference apparatus 100 has an image recognition function of, for example, recognizing, by deep learning using a captured image as input data, an object in the image, and classifying the object into a predetermined category (class). The inference apparatus 100 includes a volatile memory 102, an inference unit 108, an interface (IF) control unit 109, and an image processing unit 113.

The expansion apparatus 120 that expands the function of the inference processing of the inference apparatus 100 can mechanically detachably and electrically be connected to the inference apparatus 100. The inference unit 108 executes image recognition processing by inference processing using a learned inference model using, as input data, image data output from the image processing unit 113. The interface control unit 109 executes control to connect the expansion apparatus 120 to the inference apparatus 100.

The learned inference model is formed by a neural network, and is formed by a Convolutional Neural Network (CNN) in the present embodiment. The CNN includes a plurality of processing layers such as an input layer, intermediate layers (convolution layer, pooling layer, and fully-connected layer), and an output layer, and data input to each node of each processing layer is weighted by a learned inference parameter (weighting coefficient or bias value) and then output to the succeeding processing layer. In the present embodiment, arithmetic processes in the respective processing layers in the inference model are appropriately distributed to the hardware of the inference apparatus 100 and the hardware of the expansion apparatus 120, thereby making it possible to effectively utilize the hardware resources of both the inference apparatus 100 and the expansion apparatus 120 for the inference processing.

Note that the inference model of the present embodiment is not limited to the CNN and may be formed by a Recurrent Neural Network (RNN).

The image processing unit 113 performs various kinds of image processes for image capture data obtained by capturing an object, thereby generating image data such as a still image or a moving image. The inference unit 108 executes inference processing using the image data as input data, and performs image recognition processing. The interface control unit 109 executes control to connect the expansion apparatus 120 to the inference apparatus 100.

The expansion apparatus 120 is detachable from the inference apparatus 100, and includes hardware for expanding the function of the inference processing of the inference apparatus 100. In addition, the expansion apparatus 120 can access a volatile memory 121. The volatile memory 121 stores input data and output data at the time of inference processing and intermediate data generated at the time of the inference processing, and also stores information (to be referred to as dictionary data) concerning an inference parameter, a neural network structure, and the like.

### <Configuration of Inference Apparatus 100>

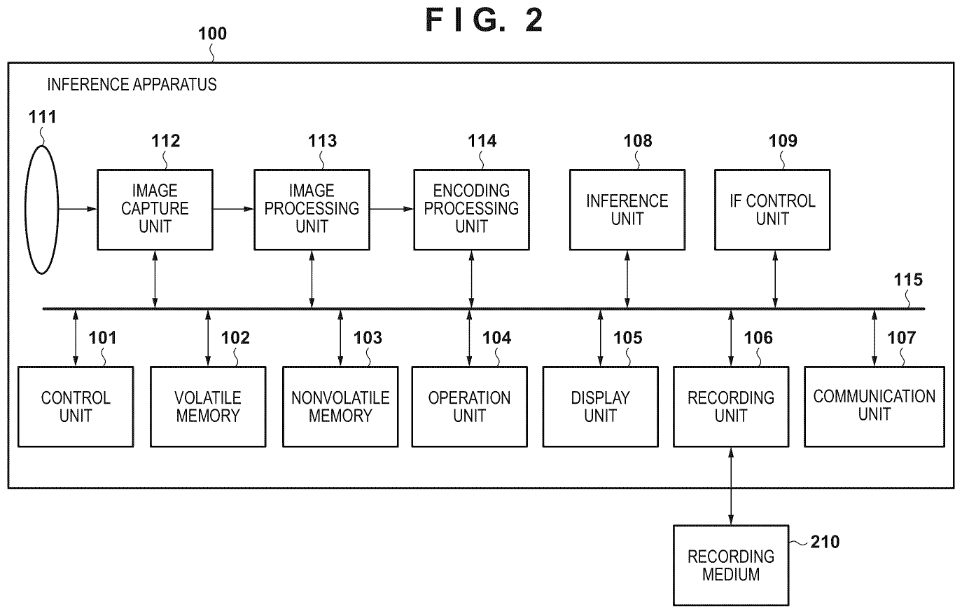

FIG. 2 is a block diagram showing the configuration of the inference apparatus 100 according to the first embodiment.

The inference apparatus 100 includes a control unit 101, the volatile memory 102, a nonvolatile memory 103, an operation unit 104, a display unit 105, a recording unit 106, a communication unit 107, the inference unit 108, the interface control unit 109, a lens 111, an image capture unit 112, the image processing unit 113, an encoding processing unit 114, and an internal bus 115.

The control unit 101 includes a processor (CPU) that performs arithmetic processing and control processing of the inference apparatus 100, and controls each component of the inference apparatus 100 by executing a control program stored in the nonvolatile memory 103.

The volatile memory 102 is a RAM. Constants and variables for the operation of the control unit 101, and a control program, an inference program, and the like read out from the nonvolatile memory 103 are loaded into the volatile memory 102. Furthermore, the volatile memory 102 stores information such as an inference program and image data received by the communication unit 107 from an external apparatus. The volatile memory 102 also stores image data obtained by the image capture unit 112, and image data processed by the image processing unit 113, the encoding processing unit 114, and the like. The volatile memory 102 has a sufficient storage capacity to hold these pieces of information.

The nonvolatile memory 103 is an electrically erasable/recordable EEPROM, flash memory, or the like. The nonvolatile memory 103 stores constants, control programs, and the like for the operation of the control unit 101, and an inference program and the like used by the inference unit 108 for inference processing. The inference program includes an inference model, a secret model, an inference parameter, and decoding information used by the inference unit 108 for inference processing.

The operation unit 104 is an operation member including various kinds of switches, buttons, and a touch panel for accepting various kinds of operations from the user and notifying the control unit 101 of them. The operation unit 104 provides a user interface used by the user to operate the inference apparatus 100.

The display unit 105 displays a display screen of a display device by rendering display data generated by the image processing unit 113. The display unit 105 has an On Screen Display (OSD) function of superimposing and displaying setting information or operation information on a Graphical User Interface (GUI) such as a menu for various settings on the display screen. The display unit 105 is formed by a liquid crystal display, an organic EL display, or the like.

The recording unit 106 is an interface that controls access to a recording medium 110. The recording unit 106 controls write and readout of data in and from the recording medium 110 based on an instruction of the control unit 101. Image data, a learning program used by the learning unit 208 for learning processing, and the like are recorded in the recording medium 110. The recording medium 110 is formed by a memory card, a hard disk, or the like.

The communication unit 107 controls communication with an external apparatus based on an instruction of the control unit 101. The communication unit 107 generates a modulation signal complying with a wireless communication standard (wireless LAN) such as IEEE 802.11, outputs the signal to the external apparatus, and receives a modulation signal from the external apparatus. Note that the communication method is not limited to the wireless LAN, and may be a wired LAN or USB connected by a wired cable. The communication unit 107 can transmit/receive a video signal complying with a communication standard such as High Definition Multimedia Interface (HDMI®) or Serial Digital Interface (SDI).

The inference unit 108 executes inference processing using the learned inference model and the inference parameter in accordance with the inference program. The inference unit 108 includes an area for temporarily storing the inference parameter. In addition, the inference unit 108 has a function of decoding encoded input data and inference parameter.

The inference processing by the inference unit 108 can be executed by a Graphics Processing Unit (GPU) or a Digital Signal Processor (DSP). The GPU or DSP is a processor capable of performing an enormous amount of product-sum operations, and has arithmetic processing capability of performing a matrix operation of a neural network within a short time. Note that in the inference processing, the CPU of the control unit 101 and the GPU or DSP may perform arithmetic processing in cooperation with each other or one of the CPU of the control unit 101 and the GPU or DSP may perform arithmetic processing.

The interface control unit 109 controls data communication with an edge device such as the expansion apparatus 120 connected to the inference apparatus 100. Peripheral Component Interconnect (PCI), Universal Serial Bus (USB), or another interface is applicable to communication with the edge device.

The shooting lens (lens unit) 111 includes a lens group (not shown) including a zoom lens and a focus lens, a lens control unit (not shown), and a stop (not shown), and forms an optical image of an object on the imaging surface of the image capture unit 112.

The image capture unit 112 includes an image sensor formed by a Charge-Coupled Device (CCD), a Complementary Metal Oxide Semiconductor (CMOS) element, and the like, and converts an optical image of an object into an electrical signal.

The image processing unit 113 includes a processor such as a GPU that executes various kinds of image processes for image data output from the image capture unit 112 or image data read out from the volatile memory 102. The image processing unit 113 converts the image data having undergone the image processing into an image file in a predetermined format (for example, JPEG), and records the image file in the recording medium 110. In addition, the image processing unit 113 generates display data for displaying an image on the display unit 105.

The encoding processing unit 114 encodes the image data processed by the image processing unit 113 by intra-frame prediction coding (intra-screen prediction coding), inter-frame prediction coding (inter-screen prediction coding), or the like.

The above-described respective components are connected to be able to transmit/receive data to/from each other via the internal bus 115.

### <Apparatus Configuration of Information Processing Apparatus 200>

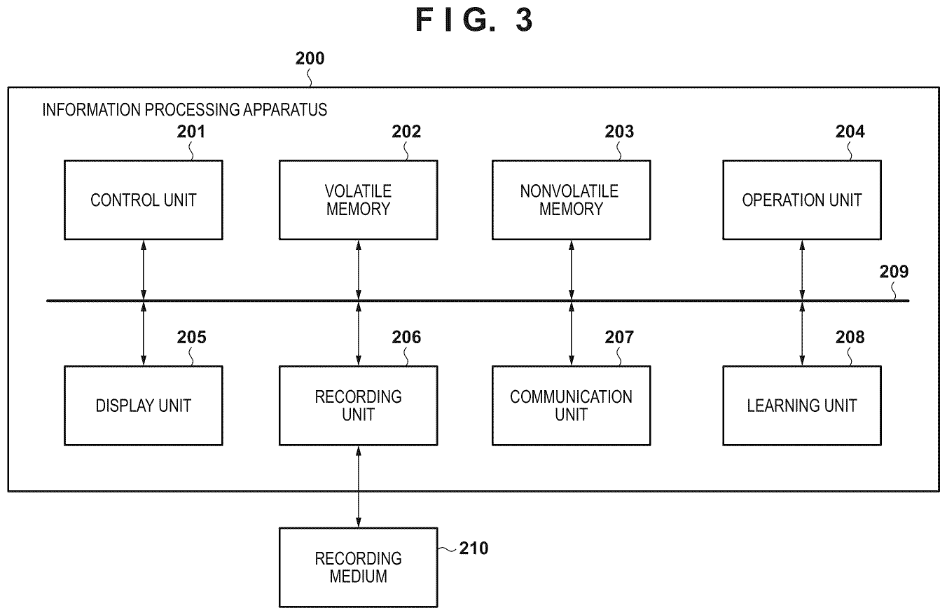

The configuration and function of an information processing apparatus 200 according to the first embodiment will be described next with reference to FIG. 3.

The information processing apparatus 200 is a desktop or notebook personal computer (PC), or the like.

The information processing apparatus 200 includes a control unit 201, a volatile memory 202, a nonvolatile memory 203, an operation unit 204, a display unit 205, a recording unit 206, a communication unit 207, a learning unit 208, and an internal bus 209.

The control unit 201 includes a processor (CPU) that performs arithmetic processing and control processing of the information processing apparatus 200, and controls each component of the information processing apparatus 200 by executing a control program stored in the nonvolatile memory 203.

The volatile memory 202 is a RAM. Constants, variables, programs, and the like for the operation of the control unit 201, and a learning program and the like used by the learning unit 208 for learning processing are loaded into the volatile memory 202. The learning program includes information such as learning data, supervisory data, an inference parameter, and a neural network structure of an interference model.

The nonvolatile memory 203 is an electrically erasable/recordable EEPROM, flash memory, or the like. The nonvolatile memory 203 stores constants, control programs, and the like for the operation of the control unit 201, and a learning program and the like used by the learning unit 208 for learning processing.

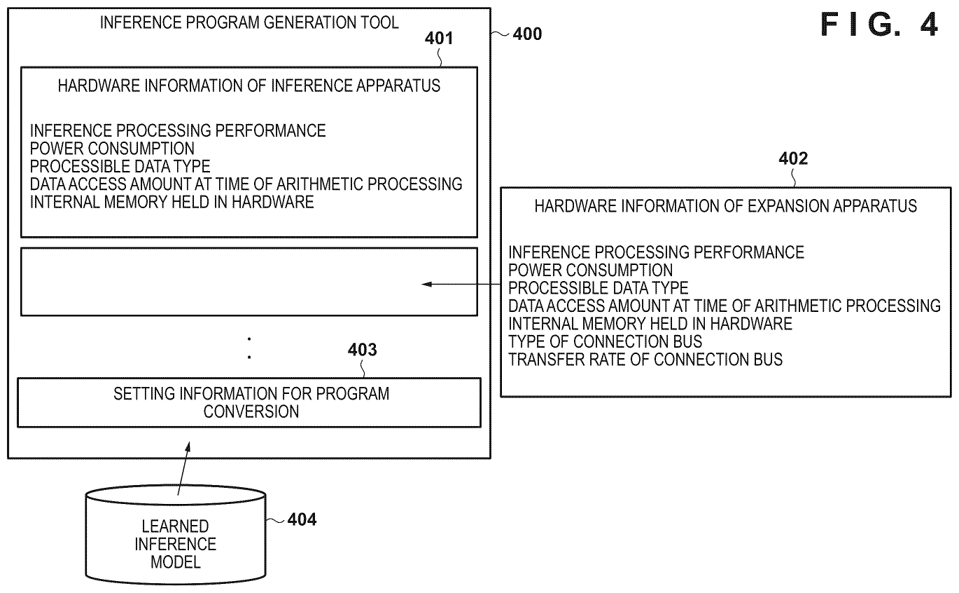

In addition, the nonvolatile memory 203 stores an Operating System (OS) as basic software to be executed by the control unit 201, and applications for realizing appliable functions in cooperation with the OS. In the present embodiment, the nonvolatile memory 203 stores an application for providing an inference program generation tool to be described later with reference to FIG. 4. The generation processing of the inference program according to the present embodiment is implemented by reading software provided by the application. Note that the application includes software for using the basic functions of the OS installed in the information processing apparatus 200.

The operation unit 204 is an operation member or a remote controller including various kinds of switches, buttons, and a touch panel for accepting various kinds of operations from the user and notifying the control unit 201 of them.

The display unit 205 includes a liquid crystal panel or an organic EL panel, and displays various kinds of information and a Graphical User Interface (GUI) in accordance with an instruction of the control unit 201.

The recording unit 206 is an interface that controls access to a recording medium 210. The recording unit 206 controls write and readout of data in and from the recording medium 210 based on an instruction of the control unit 201. The learning program used by the learning unit 208 for learning processing and the like are recorded in the recording medium 210. The recording medium 210 is formed by a memory card, a hard disk, or the like.

The communication unit 207 includes an interface for performing wireless communication or wired communication with an external apparatus. A wireless communication interface is, for example, a wireless Local Area Network (LAN) complying with a wireless communication standard of IEEE 802.11n/a/g/b. The communication unit 207 is connected to an external access point by a wireless LAN, and performs wireless communication with an external apparatus via the access point. Note that the wireless communication interface is not limited to the wireless LAN, and infrared communication, Bluetooth®, Bluetooth Low Energy, Wireless USB, or the like may be used. A wired communication interface is a USB cable, HDMI®, IEEE 1394, or the like. The communication unit 207 communicates with an external apparatus including the inference apparatus 100 and the expansion apparatus 120, and exchanges image data, control data, the learning program, and the like.

The learning unit 208 has a machine learning function including deep learning using a neural network. The learning unit 208 executes learning processing of an inference model and an inference parameter in accordance with the learning program including information such as learning data, supervisory data, the inference parameter, and the neural network structure of the inference model stored in the recording medium 210. Note that the various kinds of data used for the learning processing may be received by the communication unit 207 from an external apparatus. In this case, it is possible to reduce the resource consumption amount of the information processing apparatus 200.

The learning unit 208 includes a GPU or a Digital Signal Processor (DSP). The learning processing by the learning unit 208 can be executed by the GPU or DSP. The GPU or DSP is a processor capable of performing an enormous amount of product-sum operations, and has arithmetic processing capability of performing a matrix operation of a neural network within a short time. Note that in the learning processing, the CPU of the control unit 201 and the GPU of the learning unit 208 may perform arithmetic processing in cooperation with each other or one of the CPU of the control unit 201 and the GPU of the learning unit 208 may perform arithmetic processing.

Note that similar to the inference unit 108, the learning unit 208 can execute, for input data, inference processing by deep learning using a neural network based on the inference model and the inference parameter.

The above-described respective components are connected to be able to transmit/receive data to/from each other via the internal bus 209.

### <Inference Program Generation Tool>

An inference program generation tool 400 provided by the information processing apparatus 200 according to the first embodiment will be described next with reference to FIG. 4.

The inference program generation tool 400 is a support tool for generating program codes of the inference program for executing the inference processing in the inference apparatus 100 and the expansion apparatus 120. The support tool 400 is provided when the control unit 201 of the information processing apparatus 200 executes the application program of the support tool 400 stored in the nonvolatile memory 203.

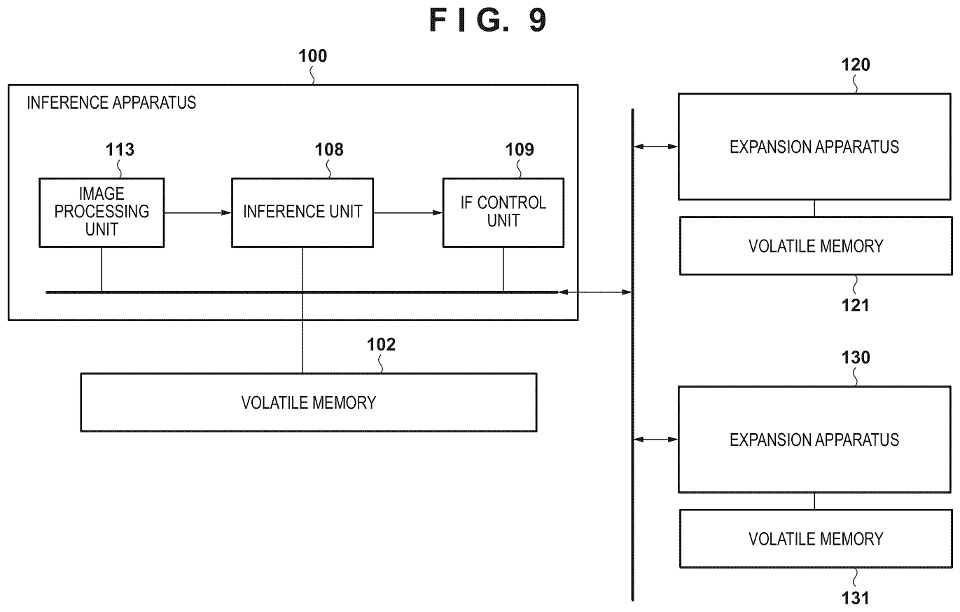

As shown in FIG. 4, data used by the support tool 400 to generate the inference program include first information 401 concerning the hardware of the inference apparatus 100 as information concerning the inference processing executed in the inference unit 108 of the inference apparatus 100, second information 402 concerning the hardware of the expansion apparatus 120 as information concerning the inference processing of the expansion apparatus 120, and third information 403 concerning the hardware setting at the time of program conversion. Note that as in the third embodiment to be described later with reference to FIG. 9, in a case where a plurality of expansion apparatuses 120 and 130 are connected to the inference apparatus 100, the second information 402 exists for each expansion apparatus. The support tool 400 converts the inference program including a learned inference model 404 based on the first information 401 of the inference apparatus 100, the second information 402 of the expansion apparatus 120, and the third information 403 for program conversion, thereby generating program codes operable in the inference apparatus 100 and the expansion apparatus 120.

The first information 401 of the inference apparatus 100 includes items concerning the scale and operating frequency of a product-sum operation circuit as the inference processing performance of the inference unit 108, power consumption, a processible data type (floating-point number, integer, and the number of bits such as 8 bits or 16 bits), a data access amount at the time of arithmetic processing, and hardware such as an internal memory held in hardware. The first information 401 of the inference apparatus 100 includes information that can be determined by actually executing a simulation, and further includes, in this case, information necessary to execute the simulation. Note that the first information 401 of the inference apparatus 100 is not limited to the above-described pieces of information and may include other information.

Similar to the first information 401 of the inference apparatus 100, the second information 402 of the expansion apparatus 120 includes items concerning the scale and operating frequency of a product-sum operation circuit as the inference processing performance of the expansion apparatus 120, power consumption, a processible data type (floating-point number, integer, and the number of bits such as 8 bits or 16 bits), a data access amount at the time of arithmetic processing, and hardware such as an internal memory held in hardware. The second information 402 of the expansion apparatus 120 includes information concerning the type of a connection bus between the inference apparatus 100 and the expansion apparatus 120 connected by the interface control unit 109, and the transfer rate of the bus. Furthermore, the second information 402 of the expansion apparatus 120 includes information that can be determined by actually executing a simulation, and further includes, in this case, information necessary to execute the simulation. Note that the second information 402 of the expansion apparatus 120 is not limited to the above-described pieces of information and may include other information. The second information 402 of the expansion apparatus 120 may be text information or a proprietary format file that can be managed by the support tool 400.

The third information 403 for program conversion includes setting information for converting the learned inference model 404 into program codes executable by the inference unit 108. The setting information includes, for example, information concerning selection of items to be compared from the first information 401 of the inference apparatus 100 and the second information 402 of the expansion apparatus 120 or priority setting of items to be compared, and setting of a threshold for each piece of information.

### <Control Processing of Information Processing Apparatus 200>

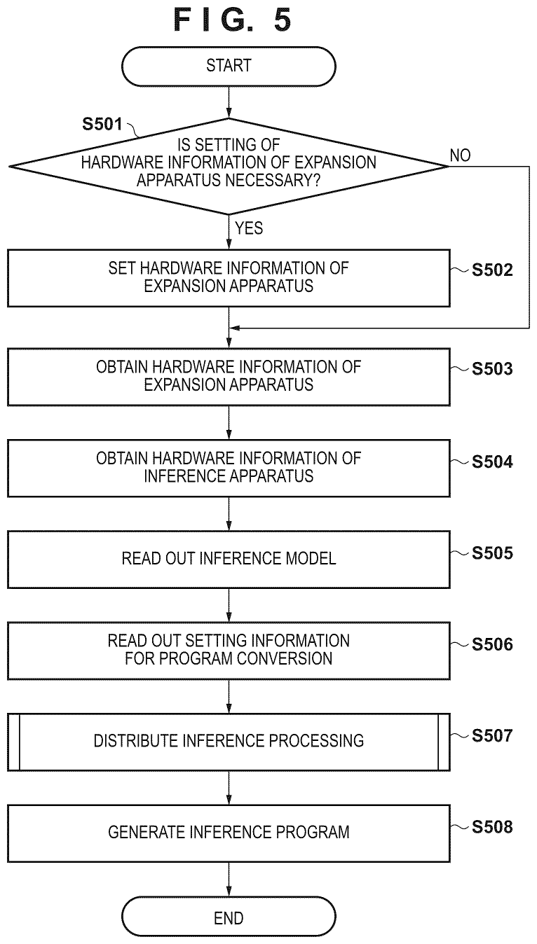

The control processing of the information processing apparatus 200 according to the first embodiment will be described next with reference to FIG. 5.

The processing shown in FIG. 5 is implemented when the control unit 201 loads a control program stored in the nonvolatile memory 203 into the volatile memory 202, executes the control program, and controls each component of the information processing apparatus 200 in a state in which the information processing apparatus 200 is powered on.

In step S501, the control unit 201 determines whether it is necessary to set the second information 402 of the expansion apparatus 120. When performing conversion processing of the inference program, the control unit 201 determines whether the second information 402 of the expansion apparatus 120 recorded in the recording medium 210 includes data. When the control unit 201 determines that the second information 402 of the expansion apparatus 120 includes data (YES in step S501), the control unit 201 advances the processing to step S502. When the control unit 201 determines that the second information 402 of the expansion apparatus 120 includes no data (NO in step S501), the control unit 201 advances the processing to step S503.

In step S502, the control unit 201 displays, on the display unit 205, a setting screen on which the second information 402 of the expansion apparatus 120 can be set. The user can input the second information 402 of the expansion apparatus 120 to the setting screen by the operation unit 204. The control unit 201 records, in the recording medium 210, as the second information 402 of the expansion apparatus 120, information input by the user via the operation unit 204, and advances the processing to step S503.

In step S503, the control unit 201 causes the recording unit 206 to read out the second information 402 of the expansion apparatus 120 from the recording medium 210 and load it into the volatile memory 202, and advances the processing to step S504.

In step S504, the control unit 201 causes the recording unit 206 to read out the first information 401 of the inference apparatus 100 from the recording medium 210 and load it into the volatile memory 202, and advances the processing to step S505.

In step S505, the control unit 201 causes the recording unit 206 to read out the learned inference model 404 from the recording medium 210 and load it into the volatile memory 202, and advances the processing to step S506.

In step S506, the control unit 201 causes the recording unit 206 to read out the third information 403 for program conversion from the recording medium 210 and load it into the volatile memory 202, and advances the processing to step S507.

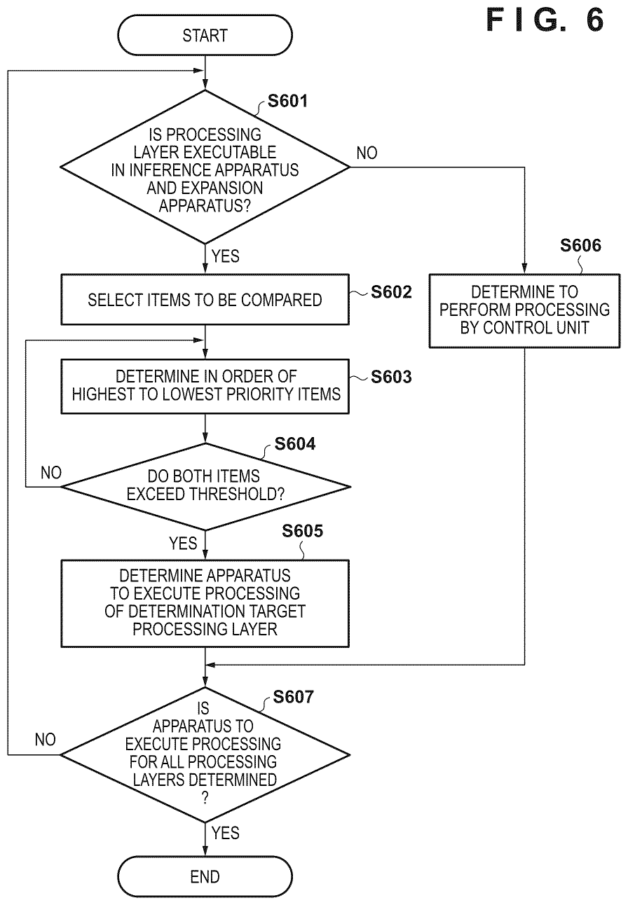

In step S507, the control unit 201 determines one of the expansion apparatus 120 and the inference unit 108 of the inference apparatus 100 to which the arithmetic processing of each processing layer in the learned inference model 404 is distributed, and advances the processing to step S508. Details of the distribution processing will be described later with reference to FIG. 6.

In step S508, the control unit 201 generates program codes of the inference program executable by the expansion apparatus 120 and the inference unit 108 of the inference apparatus 100 in accordance with the distribution method determined in step S507, and ends this processing. In this case, the control unit 201 may execute quantization processing for reduction in weight of the inference model, such as a decrease in number of bits of the inference parameter, as needed.

FIG. 6 is a flowchart illustrating the distribution processing in step S507 of FIG. 5.

In step S601, the control unit 201 determines whether the arithmetic processing of each processing layer in the learned inference model 404 is executable in both the expansion apparatus 120 and the inference unit 108 of the inference apparatus 100. When the control unit 201 determines that the arithmetic processing of each processing layer in the learned inference model 404 is executable in both the expansion apparatus 120 and the inference unit 108 of the inference apparatus 100 (YES in step S601), the control unit 201 advances the processing to step S602. When the control unit 201 determines that the arithmetic processing of each processing layer in the learned inference model 404 is inexecutable in both the expansion apparatus 120 or the inference unit 108 of the inference apparatus 100 (NO in step S601), the control unit 201 advances the processing to step S606.

In step S602, the control unit 201 selects items to be compared with respect to the first information 401 of the inference apparatus 100 and the second information of the expansion apparatus 120 based on the third information 403 for program conversion, stores the selected items in the volatile memory 202, and then advances the processing to step S603.

In step S603, the control unit 201 sets priority for the items selected in step S602, and advances the processing to step S604. For example, when the control unit 201 determines that the performance value of the inference processing including the arithmetic performance calculated from the scale and frequency of the product-sum operation circuit, the connection bus, and the data access speed has the highest priority, the control unit 201 selects the setting value of the inference processing as an item to be compared.

In step S604, the control unit 201 compares the selected item with the threshold in the order of the priority set in step S603, and determines whether both the first information 401 of the inference apparatus 100 and the second information 402 of the expansion apparatus 120 exceed the threshold. When the control unit 201 determines that both the first information 401 of the inference apparatus 100 and the second information 402 of the expansion apparatus 120 exceed the threshold (YES in step S604), the control unit 201 advances the processing to step S605. When the control unit 201 determines that neither the first information 401 of the inference apparatus 100 nor the second information 402 of the expansion apparatus 120 exceeds the threshold (NO in step S604), the control unit 201 returns the processing to step S603, and compares the comparison item having the next priority with the threshold.

In step S605, the control unit 201 determines one of the expansion apparatus 120 and the inference unit 108 of the inference apparatus 100 to execute processing with respect to the item that has been determined to exceed the threshold in step S604, and advances the processing to step S607. When the control unit 201 determines in step S604 that one of the first information 401 of the inference apparatus 100 and the second information 402 of the expansion apparatus 120 exceeds the threshold, the hardware whose information exceeds the threshold is selected. When the control unit 201 determines in step S604 that both the first information 401 of the inference apparatus 100 and the second information 402 of the expansion apparatus 120 exceed the threshold, the superior hardware is selected. For example, when the control unit 201 determines to perform comparison of the performance value of the inference processing calculated from the scale and frequency of the product-sum operation circuit and the data communication speed, the hardware higher in performance value of the inference processing is selected.

In step S606, since the arithmetic processing of each processing layer in the learned inference model 404 cannot be processed by either the expansion apparatus 120 or the inference unit 108 of the inference apparatus 100, the control unit 201 determines to perform the processing by the CPU of the control unit 101, and advances the processing to step S607.

In step S607, the control unit 201 determines whether the hardware for executing the arithmetic processing has been selected for all the processing layers in the learned inference model 404. When the control unit 201 determines that the selection of the hardware for executing the arithmetic processing is complete for all the processing layers in the learned inference model 404 (YES in step S607), the control unit 201 ends this processing. When the control unit 201 determines that the selection of the hardware for executing the arithmetic processing is not complete for all the processing layers in the learned inference model 404 (NO in step S607), the control unit 201 returns the processing to step S601.

It is possible to generate appropriate program codes in accordance with the priority setting. For example, in a case where the power consumption is prioritized in the priority setting in step S603, the processing is distributed so that the power consumption is superior, and in a case where the inference processing performance is prioritized, the processing is distributed so that the processing is executed at high speed.

### <Control Processing of Inference Apparatus 100>

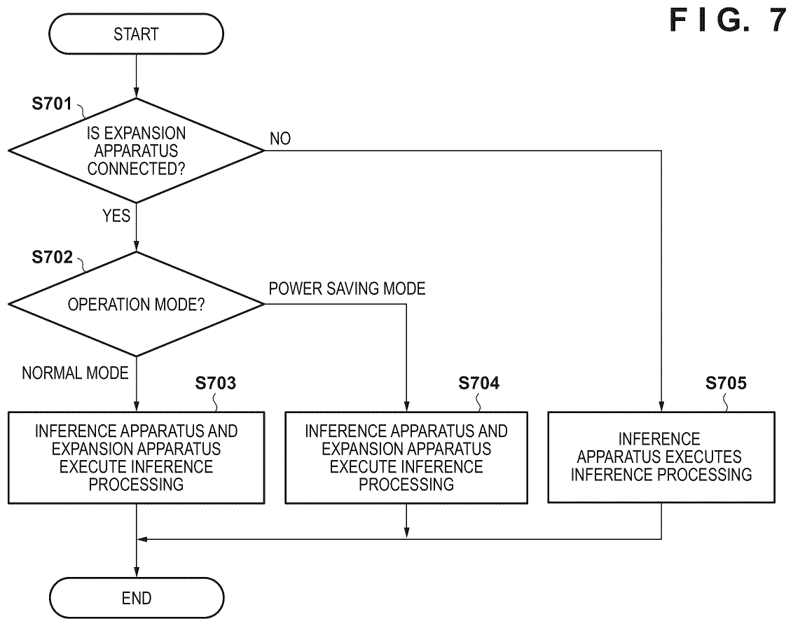

The control processing of the inference apparatus 100 according to the first embodiment will be described next with reference to FIG. 7.

The processing shown in FIG. 7 is implemented when the control unit 101 loads a control program stored in the nonvolatile memory 103 into the volatile memory 102, executes the control program, and controls each component of the inference apparatus 100 in a state in which the inference apparatus 100 is powered on. Note that as the program codes of the inference processing to be executed by the expansion apparatus 120 and the inference unit 108 of the inference apparatus 100, program codes according to a plurality of states are generated and recorded in the recording medium 210. For example, program codes in which the processing is distributed so that the power consumption becomes low and program codes in which the processing is distributed so that the inference processing performance becomes high are recorded in the recording medium 210. Program codes for executing the inference processing only by the inference unit 108 in a case where the expansion apparatus 120 is not connected to the inference apparatus 100 are also recorded in the recording medium 210.

In step S701, the control unit 101 determines whether the expansion apparatus 120 is connected by the interface control unit 109. When the control unit 101 determines that the expansion apparatus 120 is connected (YES in step S701), the control unit 101 advances the processing to step S702. When the control unit 101 determines that the expansion apparatus 120 is not connected (NO in step S701), the control unit 101 advances the processing to step S705.

In step S702, the control unit 101 obtains information concerning an operation mode, that has been loaded into the volatile memory 102, and determines the operation mode of the inference apparatus 100. When the control unit 101 determines that the operation mode is a normal mode (normal mode in step S702), the control unit 101 advances the processing to step S703. When the control unit 101 determines that the operation mode is a power saving mode of operating with power lower than in a normal state (power saving mode in step S702), the control unit 101 advances the processing to step S704.

In step S703, the control unit 101 loads, into the volatile memory 102, the inference program recorded in the recording medium 110, that is, the program codes in which the processing is distributed so that the inference processing performance becomes high, and the inference unit 108 executes the inference processing, thereby ending this processing. In this case, the expansion apparatus 120 executes the inference processing distributed to the expansion apparatus 120.

In step S704, the control unit 101 loads, into the volatile memory 102, the inference program recorded in the recording medium 110, that is, the program codes in which the processing is distributed so that the power consumption becomes low, and the inference unit 108 executes the inference processing, thereby ending this processing. In this case, the expansion apparatus 120 executes the inference processing distributed to the expansion apparatus 120.

In step S705, the control unit 101 loads, into the volatile memory 102, the inference program recorded in the recording medium 110, that is, the program codes in which the inference processing is executed only by the inference unit 108, and the inference unit 108 executes the inference processing, thereby ending this processing.

As described above, the inference apparatus 100 and the expansion apparatus 120 execute the inference processing distributed to the inference apparatus 100 and the expansion apparatus 120 in accordance with a predetermined condition such as the operation mode of the inference apparatus 100.

As described above, according to the first embodiment, in a case where the expansion apparatus 120 is connected to the inference apparatus 100, the arithmetic processes of the respective processing layers in the inference model are appropriately distributed to the inference apparatus 100 and the expansion apparatus 120. This can effectively utilize the hardware resources of the inference apparatus 100 and the expansion apparatus 120 for executing the inference processing.

### Second Embodiment

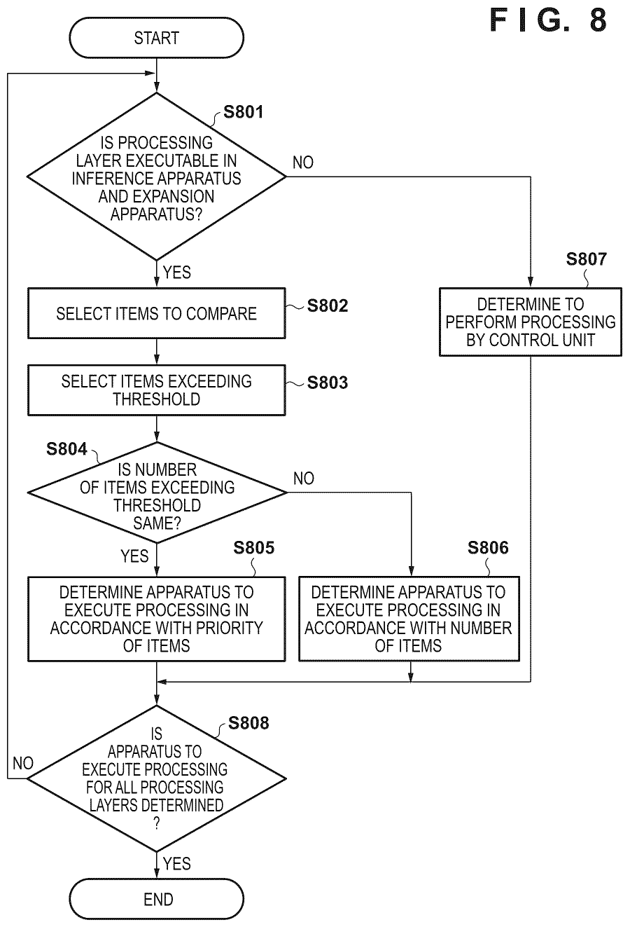

The second embodiment will be described next with reference to FIG. 8.

In the first embodiment, the processing is distributed to the expansion apparatus 120 and the inference unit 108 of the inference apparatus 100 by comparing a high-priority item with a threshold. The second embodiment will describe an example of distributing processing by comparing all items with thresholds.

Note that the configurations of an inference apparatus 100 and an information processing apparatus 200 according to the second embodiment are the same as in the first embodiment. Furthermore, the control processing of the information processing apparatus 200 according to the second embodiment is the same as in FIG. 5 of the first embodiment and the inference processing of the inference apparatus 100 is the same as in FIG. 7 of the first embodiment.

FIG. 8 is a flowchart illustrating distribution processing of the second embodiment in step S507 of FIG. 5.

Steps S801 and S802 are the same as steps S601 and S602 of FIG. 6.

In step S803, a control unit 201 selects, in first information 401 of the inference apparatus 100 and second information 402 of an expansion apparatus 120, based on third information 403 for program conversion, items exceeding thresholds from items selected in step S802, stores the items exceeding the thresholds in a volatile memory 202, and then advances the processing to step S804.

In step S804, the control unit 201 determines the number of items exceeding the thresholds, that have been selected in step S803. When the control unit 201 determines that the numbers of items exceeding the thresholds are equal to each other in the first information 401 of the inference apparatus 100 and the second information 402 of the expansion apparatus 120 (YES in step S804), the control unit 201 advances the processing to step S805. When the control unit 201 determines that the numbers of items exceeding the thresholds are different from each other in the first information 401 of the inference apparatus 100 and the second information 402 of the expansion apparatus 120 (NO in step S804), the control unit 201 advances the processing to step S806.

In step S805, the control unit 201 determines one of the expansion apparatus 120 and an inference unit 108 of the inference apparatus 100 to execute the processing with respect to the items exceeding the thresholds, that have been selected in step S803, and advances the processing to step S808. The control unit 201 performs comparison of the high-priority item among the items selected in step S803, and the superior hardware is selected. For example, when the control unit 201 determines to perform comparison of the performance value of inference processing calculated from the scale and frequency of a product-sum operation circuit and a data communication speed, the hardware higher in performance value of the inference processing is selected.

In step S806, the control unit 201 selects, from the expansion apparatus 120 and the inference unit 108 of the inference apparatus 100, the hardware having a larger number of items exceeding the thresholds, that have been selected in step S803, and advances the processing to step S808.

Steps S807 and S808 are the same as steps S607 and S608 of FIG. 6.

As described above, according to the second embodiment, in a case where one of the inference apparatus 100 and the expansion apparatus 120 is selected as hardware for executing arithmetic processing of each processing layer in a learned inference model 404, determination can be made based on comparison between all the items of the processing performance and the thresholds.

### Third Embodiment

The third embodiment will be described next with reference to FIG. 9.

Each of the first and second embodiments has explained an example in which the single expansion apparatus 120 is connected to the inference apparatus 100. The third embodiment will describe an example in which a plurality of expansion apparatuses 120 and 130 are connected to an inference apparatus 100.

Note that the configurations of the inference apparatus 100 and an information processing apparatus 200 according to the third embodiment are the same as those shown in FIGS. 2 and 3 of the first embodiment.

FIG. 9 is a block diagram showing a system configuration including the inference apparatus 100 and the plurality of expansion apparatuses 120 and 130 according to the third embodiment.

The plurality of expansion apparatuses 120 and 130 can mechanically detachably and electrically be connected to the inference apparatus 100. The configuration of each of the expansion apparatuses 120 and 130 is the same as that shown in FIG. 1, and a volatile memory 131 is connected to the expansion apparatus 130. Note that for the sake of descriptive simplicity, the configuration in which the two expansion apparatuses 120 and 130 are connected is exemplified in the example of FIG. 9 but three or more expansion apparatuses may be connected.

In a case where the plurality of expansion apparatuses 120 and 130 are connected, second information 402 of the expansion apparatus 120 shown in FIG. 4 exists for each expansion apparatus.

Furthermore, as control processing of the information processing apparatus 200 according to the third embodiment, processing is distributed to the inference apparatus 100 and the plurality of expansion apparatuses 120 and 130 in processing shown in FIG. 5, 6, or 8. For example, in each of steps S502, S503, S507, and S508 of FIG. 5, all items of all the expansion apparatuses are processed in the processing of FIG. 6 or 8.

In addition, the control processing of the inference apparatus 100 according to the third embodiment is executed in the processing shown in FIG. 7 on the assumption that a plurality of expansion apparatuses are connected. For example, in FIG. 7, a control unit 101 determines in step S701 whether a plurality of expansion apparatuses are attached, and executes, in step S703 or S704, inference processing by program codes in which the processing is distributed to the inference apparatus 100 and the plurality of expansion apparatuses 120 and 130.

As described above, according to the third embodiment, in a case where one of the inference apparatus 100 and the expansion apparatus 120 is selected as hardware for executing arithmetic processing of each processing layer in a learned inference model 404, even if a plurality of expansion apparatuses are connected, it is possible to appropriately make determination.

Note that each of the above-described embodiments has explained an example in which the information processing apparatus 200 automatically determines a method of distributing inference processing. However, for example, a function of allowing the user to manually determine a method of distributing inference processing may be added to a support tool 400 shown in FIG. 4.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-113902, filed Jul. 11, 2023 which is hereby incorporated by reference herein in its entirety.

What is claimed is:

1. An information processing apparatus comprising:
a generation unit that generates a program for executing inference processing using a learned inference model, the generated program including a first program for executing first processing, the first program being generated based on first information concerning inference processing hardware of a first inference apparatus and a second program for executing second processing, the second program being generated based on second information concerning inference processing hardware of one or more second inference apparatus; and
a control unit that distributes the inference processing to the first inference apparatus to execute first processing and to one or more second inference apparatus connectable to the first inference apparatus to execute second processing.

2. The apparatus according to claim 1, wherein the generation unit converts the program for executing the inference processing into the program for executing the first processing and the program for executing the second processing based on the first information and the second information.

3. The apparatus according to claim 2, wherein the generation unit executes the conversion based on third information concerning a setting for program conversion.

4. The apparatus according to claim 1, wherein the control unit selects an item to be compared from the first information and the second information, and determines a method of distributing the inference processing by comparing the item with a threshold.

5. The apparatus according to claim 4, wherein the control unit selects an item to be compared from the first information and the second information in descending order of priority, and determines a method of distributing the inference processing by comparing the item with a threshold.

6. The apparatus according to claim 1, wherein the control unit determines a method of distributing the inference processing by comparing all items of the first information and the second information with thresholds.

7. The apparatus according to claim 6, wherein the control unit determines the method of distributing the inference processing in accordance with the number of items exceeding the thresholds in the first information and the second information.

8. The apparatus according to claim 7, wherein
in a case where the numbers of items exceeding the thresholds are equal to each other in the first information and the second information, the control unit determines the method of distributing the inference processing in accordance with an item having a highest priority, and
in a case where the numbers of items exceeding the thresholds are different from each other, the control unit distributes the inference processing to the inference apparatus having a larger number of items exceeding the thresholds.

9. The apparatus according to claim 1, wherein
the control unit determines whether the inference processing is executable in both the first inference apparatus and the second inference apparatus,
in a case where the inference processing is executable in both the first inference apparatus and the second inference apparatus, a method of distributing the inference processing is determined, and
in a case where the inference processing is not executable in both the first inference apparatus or the second inference apparatus, it is determined to execute the inference processing by hardware different from the first inference apparatus and the second inference apparatus without determining a method of distributing the inference processing.

10. The apparatus according to claim 1, wherein each of the first information and the second information includes at least one of inference processing performance, power consumption, a processible data type, a data access amount at the time of arithmetic processing, and information concerning an internal memory.

11. The apparatus according to claim 10, wherein the second information includes at least one of a type of a connection bus between the first inference apparatus and the second inference apparatus and information concerning a transfer rate.

12. The apparatus according to claim 1, further comprising a determination unit that determines, by a user, a method of distributing the inference processing.

13. The apparatus according to claim 1, further comprising a setting unit that allows a user to set the second information.

14. The apparatus according to claim 2, wherein the conversion includes quantization processing for reducing a weight of the inference model.

15. The apparatus according to claim 1, wherein the second inference apparatus includes one or more expansion apparatus for expanding a function of the inference processing of the first inference apparatus.

16. The apparatus according to claim 1, wherein
the inference model includes a plurality of processing layers,
the inference processing includes arithmetic processing in each processing layer, and
the control unit distributes the arithmetic processing in each processing layer to one of the first processing and the second processing.

17. An inference apparatus comprising:
an inference unit that executes inference processing using a learned inference model;
an interface unit that can connect one or more expansion apparatus for expanding a function of the inference processing;
a determination unit that determines whether the expansion apparatus is connected by the interface unit; and
a control unit that executes first processing in accordance with a predetermined condition, in a case where the inference processing is distributed to the first processing to be executed in the inference apparatus and second processing to be executed in the expansion apparatus.

18. The apparatus according to claim 17, wherein
the predetermined condition is an operation mode of the inference apparatus, and
in a case where the inference apparatus is in a mode of operating with power lower than in a normal state, the inference processing is distributed so that power consumption becomes lower than in a normal state.

19. The apparatus according to claim 17, wherein
the predetermined condition is an operation mode of the inference apparatus, and
in a case the inference apparatus is not in a mode of operating with power lower than in a normal state, the inference processing is distributed so that inference processing performance becomes higher than in a normal state.

20. The apparatus according to claim 17, wherein in a case where the expansion apparatus is not connected, the inference unit executes the inference processing.

21. A control method of an information processing apparatus that executes inference processing using a learned inference model, the control method comprising:
distributing the inference processing to a first inference apparatus to execute first processing and to one or more second inference apparatus connectable to the first inference apparatus to execute second processing; and
generating a program for executing the inference processing using the learned inference model, the generated program including a first program for executing the first processing, the first program being generated based on first information concerning inference processing hardware of the first inference apparatus and a second program for executing the second processing, the second program being generated based on second information concerning inference processing hardware of one or more second inference apparatus.

22. A control method of an inference apparatus which includes an inference unit that executes inference processing using a learned inference model, and an interface unit that can connect one or more expansion apparatus for expanding a function of the inference processing,
the control method comprising:
determining whether the expansion apparatus is connected by the interface unit; and
executing first processing in accordance with a predetermined condition, in a case where the inference processing is distributed to the first processing to be executed in the inference apparatus and second processing to be executed in the expansion apparatus.

23. A non-transitory computer-readable storage medium storing a program for causing a computer to function as an information processing apparatus comprising:
a generation unit that generates a program for executing inference processing using a learned inference model, the generated program including a first program for executing first processing, the first program being generated based on first information concerning inference processing hardware of a first inference apparatus and a second program for executing second processing, the second program being generated based on second information concerning inference processing hardware of one or more second inference apparatus; and
a control unit that distributes the inference processing to the first inference apparatus to execute first processing and to one or more second inference apparatus connectable to the first inference apparatus to execute second processing.

24. A non-transitory computer-readable storage medium storing a program for causing a computer to function as an inference apparatus comprising:
an inference unit that executes inference processing using a learned inference model;
an interface unit that can connect one or more expansion apparatus for expanding a function of the inference processing;
a determination unit that determines whether the expansion apparatus is connected by the interface unit; and
a control unit that executes first processing in accordance with a predetermined condition, in a case where the inference processing is distributed to the first processing to be executed in the inference apparatus and second processing to be executed in the expansion apparatus.
